(19) United States
(12) Patent Application Publication
(10) Pub. No.: US 2026/0364541 A1
(43) Pub. Date: Nov. 19, 2026

(54) NARROW PORE DISTRIBUTION PVDF UF MEMBRANES MADE WITH SAFER SOLVENTS

(71) Applicant: Arkema Inc., King of Prussia, PA (US)

(72) Inventor: Walter P. KOSAR, King of Prussia, PA (US)

(21) Appl. No.: 19/133,776

(22) PCT Filed: Nov. 21, 2023
(86) PCT No.: PCT/US2023/080640

§ 371 Date: May 29, 2025

Related U.S. Application Data
(60) Provisional application No. 63/428,845, filed on Nov. 30, 2022.

(51) Int. Cl. B01D 71/34; B01D 61/14; B01D 67/00; B01D 69/04; B01D 69/06; B01D 69/08; C02F 1/44

(52) U.S. Cl. CPC B01D 71/34; B01D 61/145; B01D 67/0011; B01D 67/0088; B01D 67/0093; B01D 67/0095; B01D 69/04; B01D 69/06; B01D 69/08; C02F 1/444; B01D 2323/219

(57) ABSTRACT

The invention discloses a porous fluoropolymer membrane fabrication comprising a blend of N-butylpyrrolidone and co-solvents derived from lactic acid with at least 50% or greater of N-butylpyrrolidone in the solvent system.

### FIELD OF THE INVENTION

The present invention relates to: a membrane dope solution comprising at least one polymer P, at least one water soluble or hydrogel polymer H, and a solvent blend of N-butylpyrrolidone (“NBP”) with lactic acid derivatives; and to the process of making a membrane and the use of this membrane for liquid filtration.

### BACKGROUND

Polyvinylidene fluoride (PVDF) and polyvinylidene fluoride-co-hexafluoropropylene (PVDF-HFP) copolymers are high performance polymers that are used in a variety of technical applications because of their mechanical properties and their chemical and thermal stability. Polyvinylidene fluoride (PVDF) has limited solubility in many common solvents.

One technical application of PVDF polymers is as raw materials for the production of membranes, for example hollow fiber and flat sheet membranes. The process of producing PVDF membranes includes dissolving PVDF polymers in a solvent, coagulating the PVDF polymer from such solvent and further post-treatment steps.

Applicants have found that the selection of the solvent is essential to the process and has impact on the properties of the obtained membrane, including but not limited to the membranes' pore size, water permeability, and mechanical strength.

Two recent publications describe use of pure NBP solvent to cast PVDF or PVDF-HFP resin membranes; Marino et al., Journal of Membrane Science 542 (2017) 418-429 (https://doi.org/10.1016/j.memsci.2017.08.038) and Russo et al., Polymers 2021, 13, 2579. https://doi.org/10.3390/polym13152579. The Russo et al. used PVDF homopolymer (6010) to make flat sheet membranes, while an HFP-VF2 copolymer was used by Marino et al. In both articles, the membranes had larger bubble point pore size and BPD/MPD ratios than those described in this invention and all had lower permeability.

Pacheco et al (U.S. Pat. No. 6,126,826) teaches a method for preparing PVDF flat sheet membranes with controlled pore size. They highlight the benefit of controlling smaller pore size for improved rejection during filtration. However, their method relied on use of toxic NMP solvent. It is also unclear in U.S. Pat. No. 6,126,826 what the ratio between bubble point diameter and mean pore diameter was. Their pore size numbers seem to be derived from SEM analysis of the membrane surface. Unfortunately, SEM measurements require a dry sample imaged under high vacuum, which may cause pore shrinkage and therefore underestimate the true pore size in a wet state. The bubble point pressure data in U.S. Pat. No. 6,126,826 (run with methanol wetting fluid) indicate bubble point pore sizes greater than 100 nm, which is greater than the upper pore size limit obtained here.

U.S. Pat. No. 6,110,309 describes flat sheet membranes manufactures using toxic solvents and has a large pore size.

In the field of solvents, there is an ongoing demand for solvents that can replace presently used solvents such as NMP. For polyvinylidene fluoride (“PVDF”), new solvents are needed to prepare solutions with a high content of PVDF without turbidity. Membranes formed using new alternate solvents must have comparable properties in terms of pore size and permeability when compared to using more hazardous solvents such as NMP.

It is an object of the present invention to provide a solvent system for making polyvinylidene fluoride (PVDF) membranes that is less toxic than the presently used solvents, replacing solvent such as N-Methylpyrrolidone (NMP), N,N-Dimethylacetamide (DMAC), and N,N-Dimethylformamide, (DMF). The solvents currently used in polymer membrane manufacturing have hazards associated with carcinogenicity or reproductive toxicity. The European Union recently enacted policies to eliminate the use of toxic solvents for in all industrial applications ((EC) No 1907/2006 and subsequent annexes). Use of safer solvents reduces manufacturing hazards in membrane production and helps to ensure future production of polymeric based water filtration membranes.

This invention provides a solvent system that reduces toxic solvent and does not require substantial reformulation or process adjustments from current methods. The invention provides a safer solvent or solvent blend for casting PVDF membranes by the non-solvent induced phase separation process (“NIPS”). The safer solvent is N-butylypyrrolidone. The solvent blend or mixtures contain a majority portion of N-butylpyrrolidone with lactic acid derivatives, such as ethyl lactate, methyl lactate, or N,N-dimethyl lactamide, as minority portion co-solvents. These co-solvents are also less toxic and are bio-sourced. It has been discovered that a blend of N-butylpyrrolidone and co-solvents derived from lactic acid having at least 50 wt % or greater of N-butylpyrrolidone in the mixture can produce PVDF membranes with comparable permeability to membranes made with pure NMP solvent. Replacing NMP with NBP reduces toxic solvent in the environment. The porous PVDF filtration membrane produced from using the above described solvent system has a narrow pore size distribution, maximum pore size (measured by capillary flow porometry) less than 90 nm, mean pore size ≤45 nm, and water permeability ≥650 LMHB. The ratio of maximum pore size to mean pore size in these membranes is less than 2.5. The addition of the lactic acid derivatives also improves the membrane formation time (as measure by the release time) by at least 20% as compared to pure NBP as the solvent. The blend therefore provides a previously unknown benefit over using pure NBP. These properties could be very useful in biopharmaceutical membranes where narrow pore distributions and high permeability are desirable to optimize manufacturing productivity of high value biologic drugs. Specifically, a low ratio between largest pore size (commonly referred to as the bubble point pore diameter) and the mean pore size (commonly referred to as the mean pore diameter) improves selectivity and reduces contamination from larger particles.

We discovered a further, and important, benefit of using blends of lactate solvents with NBP to reduce the time for membrane formation. This was observed by noting the point at which the flat sheet membrane began releasing from the surface of the glass plate it was cast on, after immersion into the water bath. Pure NBP formulations took over 2 minutes to release from the glass plate, which the lactate solvent blends consistently released around 90 seconds after immersion into the water bath. Without being bound by theory it is thought the hydroxyl group on the lactate solvents increased the phase inversion speed when contacted with water. Reducing the membrane formation time is important to maintaining a practical production line speed in a commercial production process. The lactate solvent blends increased the phase inversion speed by 35% over pure NBP formulations.

We further discovered that formulations with both lactate solvent blends and PMMA acrylic resin had even faster phase inversion, with membranes separating from the glass at 1 minute. With only NBP solvent and an acrylic resin additive, the phase inversion time remained longer than the lactate solvent blends, but faster than NBP formulations without acrylic resin additive. Finally, we noted the acrylic resin blends had very high water permeability, exceeding formulations without acrylic resin additive.

### BRIEF SUMMARY OF INVENTION

The invention provides a dope solution comprising a novel solvent blend that can be used in the production of PVDF membranes. The primary solvent in the novel blend is N-butylpyrrolidone (“NBP”). The cosolvents are lactic acid derivatives such as lactate esters or lactate amides. The invention also provides for a method of using the dope to make a membrane.

### ASPECTS OF THE INVENTION

Aspect 1: A dope solution for making a filtration membrane comprising a PVDF polymer, water soluble polymer and/or hydrogel “polymer H”, a solvent mixture comprising N-butylpyrrolidone and at least one water soluble lactate acid derivative, and optional additives.
Aspect 2: The dope solution of aspect 1, wherein the solvent mixture comprises at least 50 wt % or greater of N-butylpyrrolidone based on total weight of solvent.
Aspect 3: The dope solution of any one or more of aspects 1 or 2, wherein the solvent mixture comprises at least 70 wt % or greater of N-butylpyrrolidone based on total weight of solvent.
Aspect 4: The dope solution of any one or more of aspects 1 to 3, wherein the lactic acid derivative comprises at least one of an ester or an amide derivative of lactic acid.
Aspect 5: The dope solution of any one or more of aspects 1 to 4, wherein the lactic acid derivative comprises ester derivatives of lactic acid.
Aspect 6: The dope solution of any one or more of aspects 1 to 5, wherein the lactic acid derivative is selected from the group consisting of methyl lactate, ethyl lactate, propyl lactate, N,N-dimethyl lactamide, and N,N-diethyl lactamide.
Aspect 7: The dope solution of any one or more of aspects 1 to 6, wherein the lactic acid derivatives are selected from the group consisting of methyl lactate, ethyl lactate, propyl lactate and combinations thereof.
Aspect 8: The dope solution of any one or more of aspects 1 to 7, wherein the derivatives comprises N,N-dimethyl lactamide, or N,N-diethyl lactamide.
Aspect 9: The dope solution of any one or more of aspects 1 to 8, where the PVDF comprises a homopolymer.
Aspect 10: The dope solution of any one or more of aspects 1 to 3, wherein the PVDF is a copolymer comprising at least one monomer unit selected from the group consisting of HFP, TFE, CTFE, VF3, VF, and vinylacetate.
Aspect 11: The dope solution of any one or more of aspects 1 to 10, wherein the PVDF is a copolymer comprising HFP monomer units.
Aspect 12: The dope solution of any one or more of aspects 1 to 11, where the PVDF comprises a blend of different PVDF polymers.
Aspect 13: The dope solution of any one or more of aspects 1 to 12, wherein polymer His selected from the group consisting of polyvinylpyrrolidone, poly-2-ethyloxazoline, polyethylene glycol and combinations thereof.
Aspect 14: The dope solution of any one or more of aspects 1 to 13, wherein polymer H comprises polyvinylpyrrolidone.
Aspect 15: The dope solution of any one or more of aspects 1 to 14, wherein the optional additives comprise an acrylic resin in an amount of from 1-20% by weight, based on the total weight of polymer P.
Aspect 16: The dope solution of any one or more of aspects 1 to 15, wherein the optional additives comprise at least one of poly-methylmethacrylate, polymethylmethacrylate copolymers, polyhydroxylacrylates, polyhydroxyalkanoates such as polylactic acid, or insoluble hydrogel polymers such as polyhydroxyethylmethacrylate or polyvinylalcohol or combinations thereof.
Aspect 17: A method for making a PVDF membrane comprising the steps of:
   a. providing the dope solution of any of aspects 1 to 16,
   b. Casting the dope solution at 40 C or greater temperature into either a flat sheet, hollow fiber, or tubular form followed by immersing the casted dope solution into one or more non-solvent baths to form the porous membrane.
   c. Rinsing the porous membrane to remove residual solvent and additives,
   d. Optionally treating the membrane with chlorine bleach to further remove additives
   e. Optionally post treating the membrane with wetting agents such as glycerol, propylene glycol, or polyethylene glycol.
   f. Optionally drying the membranes.
Aspect 18: The polymeric membrane made by the method of aspect 17 comprising a maximum pore size (bubble point pore diameter) as measured by bubble point test of less than 90 nm; a mean pore size as measured by capillary flow porometry of 45 nm or less, and wherein the ratio of pore size between bubble point diameter and mean pore diameter is less than 2.5, preferable less than 2.1, and wherein the pure water permeability as measured by pressure filtration is 650 LMHB or greater.
Aspect 19: The use of the polymeric membrane made by the method of aspect 17 for gas or liquid filtration.
Aspect 20: The use of the polymeric membrane made by the method of aspect 17 for water or wastewater filtration.
Aspect 21: A method for filtering a fluid comprising a) providing the polymeric membrane of aspect 18 and b) passing a gas or liquid through the membrane.
Aspect 22: The method of aspect 21, wherein the fluid is water.

### BRIEF DESCRIPTION OF THE DRAWINGS

FIG. 1 shows Pore distribution of NBP solvent blend membranes vs NMP.

FIG. 2 shows Pore distribution of NBP solvent blend reinforced membranes vs NMP.

### DETAILED DESCRIPTION OF THE INVENTION

As used herein, unless otherwise indicated, percentages are weight percent, melt viscosity is measured using ASTM 3825 by a capillary rheometry at 100 sec-1 and 232 °C. All references cited are incorporated herein by reference. Bubble point pore diameter and mean pore diameters were measured by capillary flow porometry using methods described in ASTM F316.

“Copolymer” is used to mean a polymer having two or more different monomer units, including terpolymers (three different co-monomers) and higher degree polymers (greater than 3 different comonomer). “PVDF” means polyvinylidene fluoride. “PVDF” includes both homopolymer and copolymers. For example, as used herein, “PVDF” and “polyvinylidene fluoride” are used to connote both the homopolymer and copolymers, unless specifically noted otherwise. “Fluoropolymer” is used to mean a polymer comprising fluorinated monomers. The polymers may be homogeneous, heterogeneous, or random, and may have a gradient distribution of co-monomer units.

PMMA resins are resins comprising methylmethacryate monomer units but can include other acrylate co-monomers.

Hydrogel polymer means a three-dimensional crosslinked hydrophilic polymer that does not dissolve in water. The hydrogel polymer can absorb large amounts of water without dissolving, due to physical or chemical crosslinkage of the hydrophilic polymer chains.

Lactic acid derivative means a water soluble co-solvent derived from lactic acid such as lactate esters or lactate amides.

Disclosed is a dope solution used to prepare a membrane, the dope solution comprising: a polymer P, a water soluble polymer or hydrogel “polymer H”, optionally other additives, and a solvent system, wherein the solvent system comprises N-butylpyrrolidone and at least one lactic acid derivative.

The dope solution to prepare the membrane comprises a polymer P selected from the group of poly vinylidene fluoride (PVDF) homopolymers and copolymers. The term “PVDF polymer” may include a mixture of different PVDF polymers. The PVDF polymers have a melt viscosity range of has melt viscosity between 16 and 45 kilopoise, preferably between 25 and 42 kilopoise as measured by capillary rheometer at 230 C and 100 sec-1.

The polymer of the invention can be any PVDF polymer used for forming membranes by the NIPS process.

The polyvinylidene fluoride resin (PVDF) composition of the invention comprises either, a homopolymer, a copolymer, wherein the vinylidene fluoride units comprise typically and preferably greater than 70 percent of the total weight of all the monomer units in the polymer, and more preferably, comprise greater than 85 percent of the total weight of the units. Copolymers of vinylidene fluoride may be made by reacting vinylidene fluoride with one or more monomers from the group consisting of vinyl fluoride, trifluoroethene, tetrafluoroethene; tetrafluoropropene such as 2,3,3,3-tetrafluoropropene, E-1,3,3,3-tetrafluoropropene, Z-1,3,3,3-tetrafluoropropene, 1,1,2,3-tetrafluoropropene, 1,2,3,3-tetrafluoropropene, 1,1,3,3-tetrafluoropropene, chlorotetrafluoropropene; 3,3,3-trifluoro-1-propene, 1,2,3,3,3 pentafluoropropene, one or more of partly or fully fluorinated alpha-olefins such as 3,3,3,4,4-pentafluoro-1-butene, HFO-1234ze, HFO-1234yf, HFO-1233zd, hexafluoropropene, trifluoromethyl-methacrylic acid, trifluoromethyl methacrylate, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro (1,3 dioxole) and perfluoro (2,2-dimethyl-1,3-dioxole), allylic, partly fluorinated allylic, or fluorinated allylic monomers, such as 2-hydroxyethyl allyl ether or 3-allyloxypropanediol, ethene, propene. Preferred copolymers or terpolymers are formed with one or more of vinyl fluoride, chlorotrifluoroethylene, trifluoroethene, tetrafluoroethene (TFE), and hexafluoropropene (HFP).

Most preferred copolymers are formed with vinylidene fluoride and hexafluoropropene (HFP).

While an all fluoromonomer containing copolymer is preferred, non-fluorinated monomers such as vinyl acetate, methacrylic acid, and acrylic acid, may also be used to form copolymers.

Preferred copolymers include PVDF polymers comprising from about 70 to about 99 weight percent VDF monomer units, and correspondingly from about 1 to about 30 wt percent HFP monomer units; more preferably is a VDF/HFP copolymer comprising from 1 wt % to 8 wt % HFP.

Mixtures of polyvinylidene fluoride polymers is also envisioned as part of the invention, including functionalized fluoro-polymers with non-functionalized polymers, PVDF homopolymers with PVDF-HFP copolymers, and PVDF polymers having different melt viscosities.

The fluoropolymer may comprise monomer units bearing at least one of the following functions: carboxylic acid, carboxylic acid anhydride, carboxylic acid ester, epoxy groups (such as glycidyl), amide, hydroxyl, carbonyl, mercapto, sulfide, oxazoline, phenolic, ester, ether, siloxane, sulfonic, sulfuric, phosphoric or phosphonic. The function can be introduced by a chemical reaction which can be grafting or a copolymerization of the fluoromonomer with a monomer bearing at least one of the functional groups and a vinyl function capable of copolymerizing with the fluoromonomer, according to techniques well known to a person skilled in the art. Examples of such monomer units bearing functional groups can be found in U.S. Pat. Nos. 8,337,725, 5,415,958, JP20100292594, EP247029 B1, U.S. Pat. No. 9,343,744 B2, FR3079834, US20210171693 all of which are herein incorporated by reference.

The fluoropolymer may comprise recurring units bearing a carboxylic acid functional group. The monomer bearing the carboxylic acid functional group can be a (meth)acrylic acid such as acrylic acid, methacrylic acid, hydroxyethyl (meth)acrylate, hydroxypropyl (meth)acrylate and hydroxyethylhexyl (meth)acrylate. The units bearing the carboxylic acid functional group may additionally comprise a heteroatom chosen from oxygen, sulfur, nitrogen and phosphorus.

Functionality may also be introduced to the fluoropolymer by means of a chain transfer agent having functionality when used during the synthesis process. The chain transfer agent can be a polymer of molar mass less than or equal to 10 000 g/mol, preferably less than or equal to 5000 and bearing functional groups as described above. One example of a chain transfer agent of this type is a polymer of acrylic acid. According to a preferred embodiment, the chain transfer agent comprises a polymer of acrylic acid of molar mass less than or equal to 10 000 g/mol, preferably less than or equal to 5,000 g/mol.

When the fluoropolymer contains functional groups the content of functional monomer unit of the fluoropolymer is at least 0.01 mol %, preferably at least 0.1 mol %, and at most 10 mol %, preferably at most 5 mol %.

Some preferred monomers containing functional groups are those bearing a carboxylic acid functional group preferably (meth)acrylic acid type chosen from acrylic acid, methacrylic acid, hydroxyethyl (meth)acrylate, hydroxypropyl (meth)acrylate and hydroxyethylhexyl (meth)acrylate.

Preferably, the dope solution comprises 10 to 30 weight percent of polymer P, more preferably 12 to 25 weight percent, most preferably 15-20 wt % based on the total weight of the dope solution.

Polymer H—(Water Soluble and/or Hydrogel Polymers)

The water soluble or hydrogel polymer, polymer H, may help to adjust the viscosity of the dope solution. The main purpose of these hydrophilic polymeric additives is to support the formation of the pores and impart residual hydrophilicity to the membranes.

The water soluble polymer may be any known water soluble polymer. Preferred water soluble polymers are selected from the group of polyvinyl pyrrolidone (PVP); and polyalkylene oxides (also commonly referred to as polyalkylene glycols) with a molar mass of 4000 g/mol or higher. Preferred water soluble polymers include polyvinyl pyrrolidone, poly-2-ethyloxazoline, polyethylene glycol, polyethylene oxide/polypropylene oxide block copolymers and mixtures thereof. Preferred water soluble polymer are polyethylene glycol, polyvinylpyrrolidone, and poly-2-ethyloxazoline. A very preferred water soluble polymer is polyvinyl pyrrolidone.

Preferred hydrogel polymers may be selected from known examples, including polyhydroxyethylmethacrylate (poly-HEMA), poly-N-isopropylacrylamide (PNIPAM), poly-ethyleneglycolmethacrylate (PEGMA), crosslinked PVP and copolymers thereof, and hydroxy-alkylcelluloses.

When the dope solution comprises 10 to 30 weight percent of polymer P, the amount of polymer H can be from 1 to 22 wt %, based on the total weight of the dope solution.

In a preferred embodiment, the dope solution contains 12 to 25 wt % of polymer P, and 2 to 20 wt % of the water soluble polymer or hydrogel polymer, based on the total weight of the dope solution. In a more preferred embodiment, the dope solution contains 18-20 wt % of polymer P and 8-16 wt % of the water soluble or hydrogel polymer, based on the total weight of the dope solution.

In one embodiment the water-soluble polymer is PVP and the amount of PVP additive is preferably 10-16%, based on the total weight of dope solution.

The polyvinyl pyrrolidone preferably has a K value of from 10 to 120. Preferably at least one PVP present in the composition has a K value of from 12 to 60. One or more different K value polyvinyl pyrrolidones can be used. The polyvinyl pyrrolidones can be used in combination such as for example a combination of K15 with a K30, or a K15 with a K60, or a K15 with a K90, or a K30 with a K60. A given K values roughly correspond to a weight average Molecular weight (using GPC/MALLS). Generally, PVP having a K value of K30 has a weight average molecule weight in the range of 40,000 to 80,000 g/mole, K60 generally indicates a weight average molecular weight in the range of 250,000 to 500,000 g/mole, K90 generally indicates a weight average molecular weight in the range of 1 to 1.4 million g/mole. K15 is generally in the range of 7,000 to 20,000 g/mole. By “K value’ is meant Fikentscher K value (1000 k) as defined by H. Fikentscher—Cellulosechemie 13, 58-64, 71-4 (1932). (U.S. Pat. No. 2,706,701) PVP polymers are available as commercial products such as Luvitec® PVP (from BASF) or Plasdone™, Povidone, PVP K series (all from Ashland) and are sold referencing K value as an indication of molecular weights. In some embodiments a K value of 17 or less is preferred. In some embodiments a K value of 40 or less is preferred.

### Additives

Optional additives may be present in the dope solution. The optional additives are those known to one of skill in the art. Total content by weight of all optional additives in the dope are preferably from 0.1 to 30 wt % based on total dope, more preferably less than 15 wt percent, and most preferably less than 10 wt percent.

One optional additive is an acrylic resin in an amount of from 0-20% by weight, preferably 1-20%, based on the total weight of polymer P and the acrylic resin in the dope solution. Another optional additive is polyethylene glycol or polyethylene glycol copolymers with a molecular weight of between 200 and 1000 Mw.

The optional acrylic resin can be one or more PMMA resins. Such PMMA resins include, but are not limited to; PMMA homopolymer, PMMA copolymer resin containing acrylic acid ester comonomer(s); PMMA copolymer resin containing hydroxyethylmethacrylate (“HEMA”) comonomer; PMMA copolymer resin containing methoxy-polyethyleneglycol methacrylate “MPEGMA”; PMMA copolymer resin containing polyethylene glycol methacrylate comonomer; PMMA resin containing zwitterionic functional groups such as sulfobetainemethacrylate; PMMA resin containing sulfonic acid groups; block copolymer composed of a pure PMMA block and a second block containing both hydrophilic comonomer(s) such as HEMA or MPEGMA and hydrophobic comonomer(s) such as alkylacrylates.

Addition of acrylic resin in the dope provides for increased membrane permeability.

Other optional additives can include (but are not limited to), inorganic salts such as lithium chloride, magnesium chloride, ferrous chloride, and aluminum chloride; quaternary ammonium salts; propylene glycol, glycerol, organic acids, molecular sieves, silica, aluminum oxide, and activated carbon. Any optional additive known to those skilled in the art may be present in the dope solution.

### Solvent System

The solvent system comprises a blend of N-butylpyrrolidone and one or more co-solvents derived from lactic acid (“CSLA”), with at least 50 wt % or greater of N-butylpyrrolidone in the blend, wherein all CSLA have water solubility of 300 g/liter or greater or are miscible with water. Preferably the blend of N-butylpyrrolidone (NBP) and CSLA comprises a NBP:CSLA ratio (by weight) of from 50:50 to 95:5, preferably 60:40 to 95:5, more preferably 75:25 to 90:10.

Examples of CSLA derived from lactic acid include but are not limited to: methyllactate, ethyllactate, propyllactate, N,N-dimethyllactamide, or N,N-diethyllactamide.

The dope solution may comprise optional cosolvents in addition to the N-butylpyrrolidone (NBP)-lactate (CSLA) blend, hereinafter referred to as optional solvents. Preferred are optional solvents that are miscible with the N-butylpyrrolidone (NBP) and CSLA blend. Minor amounts, less than 10 wt % of the total solvent, of optional solvents could optionally be added with NBP/CSLA blend. Non limiting example of optional solvents include gamma-valerolactone, butyrolactone, propylene carbonate, ethyl levulinate or other levulinic acid derivatives.

Total solvent in the dope solution is generally between 50 and 85 weight percent of the total dope solution weight, preferably 55 to 75 wt percent of the total dope solution.

### Preparation of the Dope Solution

The dope solution may be prepared by adding the polymer P and the water-soluble polymer and/or hydrogel polymer H, in any order, to the N-butylpyrrolidone (NBP) and CSLA blend and dissolving polymer P and the water soluble polymer and/or hydrogel polymer H according to any process known in the art. Optional additives, if included, could also be added to the solvent blend with polymers P and H, or could be dissolved separately and added into the polymer dissolution mix at any stage. The dissolution process may be supported by increasing the temperature of the dope solution and/or by mechanical operations like stirring.

In one general method, the components are blended with a mixer and preferably while heating to a temperature of between 70 and 120 °C.

### Process of Making a Membrane

In the context of this application, a membrane shall be understood to be a semipermeable structure capable of separating two fluids or separating molecular and/or ionic components or particles from a liquid. A membrane acts as a selective barrier, allowing some particles, substances or chemicals to pass through, while retaining others. The membrane may have various geometries such as flat sheet, spiral wound, tubular, single bore hollow fiber, multiple bore hollow fiber, or reinforced hollow fiber.

Membranes may be produced according to a process comprising providing a dope solution comprising polymer P, water soluble polymer or hydrogel polymer H, any optional additives, and the solvent blend, casting the membrane by extruding the dope solution, passing the extruded dope solution through a non-solvent bath/coagulant and optionally oxidizing with chlorine bleach or an alternative oxidizer and then water washing the obtained membrane.

Preferably, the process for casting a membrane comprising the steps of:
a. Providing a dope solution comprising a PVDF resin, a water soluble or hydrogel polymer, and optionally additives, in a solvent comprising a N-butylpyrrolidone (NBP) and CSLA blend;
b. degassing the dope solution of step a);
c. Extruding the dope solution,
d. coagulating the dope solution by passing the extruded dope solution of step c through a non-solvent bath to form a porous membrane;
e. soaking the porous membrane in an aqueous solution;
f. Optionally soaking the porous membrane in a sodium hypochlorite solution (0.5%-7.5%) for 4-24 hours at a temperature of 20-50 °C followed by rinsing of the porous membrane with fresh water after the soaking in sodium hypochlorite;
g. Optionally soaking in an alcohol, glycerol, or glycol solution;
h. Drying the membrane

The dope solution in step a) corresponds to the dope solution described above. The main purpose of the water soluble or hydrogel polymer is to support the formation of the pores. The water-soluble polymer or hydrogel polymer may also help to adjust the viscosity of the dope solution. While not wishing to be bound by theory, it is thought that during the coagulation step d) the water-soluble polymer becomes distributed in the coagulated membrane and thus becomes the place holder for pores.

Degassing can be done at an elevated temperature or at room temperature, preferably between 50 to 80 °C.

In step d) the dope solution is contacted with a non-solvent bath also referred to as a coagulant. In this step, phase inversion or coagulation of the polymer P occurs and the porous membrane structure is formed.

In step f) the bleach solution can be at ambient temperature or at an elevated temperature, preferably from 20 °C to 50 °C.

The resultant membrane preferably has a BPD/MPD ratio of between 1.85 and 2.10. This provides for a membrane that is selective, meaning small pore size and still has sufficient flow as measured by PWP.

### Non Solvent

The polymer P should have low solubility in the non-solvent/coagulant. Suitable non-solvent bath/coagulants are, for example, liquid water, water vapor, alcohols, glycols, glycerol, or mixtures thereof.

Suitable alcohols are, for example, mono-, di- or trialkanols selected from the group of the group of C2-C4 alkanol, C2-C4 alkanediol, C3-C4 alkanetriol, polyethylene oxide with a molar mass of 100 to 1000 g/mol as they can be used as additives in the inventive dope solution. Preferred mixtures of the non-solvents are mixtures comprising liquid water and alcohols. A preferred non-solvent is a mixture of isopropanol and water with isopropanol content 50-80% by volume.

A flat sheet or hollow fiber membrane can be made using the dope solution and the method of the present invention in either a supported (cast on woven or non-woven support) or an unsupported free standing membrane format.

The membranes obtained by the process of the invention may be used for any separation purpose, for example water treatment applications, treatment of industrial or municipal waste water, desalination of sea or brackish water, dialysis, plasmolysis, food processing.

Membranes described herein can be used for water and waste water purification, biopharma processing, and food and beverage filtration.

### Examples

Abbreviations and compounds used in the examples:
PWP is pure water permeation
LMHB means liters per square meter membrane area per hour per bar applied pressure (L m⁻² h⁻¹ bar⁻¹)
NMP means N-methyl-2-pyrrolidone
NBP means N-butyl-2-pyrrolidone
DML means N,N-dimethyllactamide
EtLac means Ethyllactate
MeLac means methyllactate

### General Procedure

Formulations were made with different solvent/resin combinations, including blends with N-butylpyrrolidone and optional use of an acrylic resin additive. Control formulations (comparative) were made using pure NMP solvent. N-butylpyrrolidone (Tamisolv® NxG) available from Eastman Chemical. Dimethyl lactamide (Agnique® AMD 3L) available from BASF. PVP K15 and N-methylpyrrolidone available from ThermoScientific. Kynar®761A available from Arkema. BS520 acrylic resin was supplied by Trinseo.

Weighed out Kynar®761A PVDF powder (16 g) into 8 oz mixing jar. Added 12 g PVP K15. Added 72 g solvent (either NBP, NBP blend, or NMP control) to the jar to give a 100 g formulation. Mixed formulation with overhead mixer while heating with heating mantle. Heating cycle 70 °C/30 min, 95 °C/2 h, 105 °C/2 h. After complete dissolution, formulations were stored overnight in sealed jars at 70 °C to degas.

For formulations containing acrylic resin, ALTUGLAS® BS520 was used. These were prepared by adding a solution of BS520 in NBP (20 wt % BS520) to the mixture of Kynar® 761A, PVP and remaining solvent mix to reach the desired formulation composition. In formulations with acrylic resin the amount of Kynar 761A was 15.4 wt % and the acrylic resin was 2.1 wt % of the total formulation weight. The acrylic resin was 12% of the combined PVDF+acrylic resin weight. To obtain 2.1% of acrylic resin when using a 20 wt % solution of acrylic resin in NBP, 10.5 g of the 20 wt % solution was added to the formulation.

After overnight heating, solutions were cooled to 60 °C for one hour then transferred into 6 oz polyethylene dropper bottles.

Cast unreinforced membranes on glass plates, using 10 mil blade gap on a draw down square (8-path wet film applicator, Gardco® applicator, Paul N Gardner Company). Immersed the wet film on glass plate in 70% isopropanol/water (v/v) bath for 1 minute and then moved into a deionized water bath until membrane peeled off. (Exposure time in the 70% isopropanol was 1 minute per 10 mil of coating thickness. Thicker coatings were immersed for longer in the 70% isopropanol/30% water (v/v) bath. Moved into a deionized water bath and waited until membrane had a uniform haze and began to separate from glass before peeling off. The membranes are then transferred into second water bath 2 minutes after peel off.

After all membranes were collected from a formulation, they were soaked in deionized water which was changed twice over two hours then let sit overnight in deionized water. Soaked membranes in 100% isopropanol for 30 minutes followed by final deionized water rinse.

Dried unsupported membranes at 120 °C for 15 minutes while clamped in steel frame to prevent shrinkage. Membranes dried into smooth white sheets.

Reinforced membranes were prepared similarly, using Hollytex non-woven sheets as backing. A 15 mil wet film thickness was used for reinforced membranes. Membranes formed directly onto the non-woven backing sheet and were not peeled off. Into the isopropanol/water bath for 1.5 minutes. This was followed by 2 min in the deionized water bath. Next the membrane were transferred to an additional water bath for rinsing with the water being changes (30 minutes apart) twice and then left to soak overnight. Then IPA soaked for 30 min followed by deionized water rinse and then dried. These membrane have HTX label in the solvent mixture column which stands for Hollytex. These reinforced membranes were taped onto cardboard sheets and dried in the oven at 60 °C for 20 minutes.

Tested membranes by capillary flow porometry for pore size distribution using Galwick wetting fluid with a 2.5 cm disk sample, using PMI Automated Capillary Flow Porometer, model CFP-1500-AELHS, according to ASTM F316.

Measured water permeability using liquid permeability cell on porometer with a 4.5 cm membrane disk sample, running three replicate permeability tests, and using third cycle result. Water permeability tests were run over an increasing pressure range from 1.5 psi to 22 psi, using 1.5 psi increments and 30 second collection at each pressure step. Reported permeabilities were taken at 14.5 psi.

Summary data are presented in Table 1 for all the formulations run. Use of the solvent blend provides for a unique combination of features. The membranes obtained using the solvent blend have a maximum pore size (bubble point pore diameter) as measured by bubble point test of less than 90 nm; a mean pore size as measured by capillary flow porometry of 45 nm or less, a ratio of pore size between bubble point diameter and mean pore diameter of less than 2.5, preferably less than 2.1 and a the pure water permeability as measured by pressure filtration is 650 LMHB or greater.

“Release time” is presented as the time it took for the nascent membrane to begin lifting off the glass plate after immersion into the pure water bath. (This was after initial immersion into the 70% isopropanol bath.)

TABLE 1
Summary data for NBP mixed solvent formulation membranes

| | | | | | | Release |
|---|---|---|---|---|---|---|
| | | BPD | MPD | | PWP | time |
| Membrane | Solvent mix | (um) | (um) | BPD/MPD | (LMHB) | (sec) |
| 1Comparative | NBP | 0.0821 | 0.0389 | 2.11 | 1060 | 140 |
| 2Comparative | NBP-HTX | 0.067 | 0.0305 | 2.20 | 945 | — |
| 3 Comparative | COMPARATIVE | 0.126 | .0449 | 2.81 | 827 | 60 |
| | NMP | | | | | |
| 4 comparative | COMPARATIVE | 0.107 | 0.0634 | 1.69 | 1050 | — |
| | NMP - HTX | | | | | |
| 5 | NBP-MeLac 10% | 0.08 | 0.0415 | 1.93 | 1080 | 90 |
| 6 | NBP-EtLac 10% | 0.079 | 0.0385 | 2.05 | 1200 | 90 |
| 7 | NBP-DML 10% | 0.086 | 0.0365 | 2.34 | 700 | 90 |
| 8 | NBP-DML 45% | 0.076 | 0.0379 | 2.00 | 650 | 105 |
| 9 (support) | NBP-DML 10% | 0.074 | 0.0355 | 2.08 | 1100 | — |
| | HTX | | | | | |
| 10(support) | NBP-DML 45% | 0.066 | 0.0347 | 1.90 | 780 | — |
| | HTX | | | | | |
| 11 | NBP w BS520 | 0.082 | 0.0447 | 1.83 | 2300 | 105 |
| 12 | NBP-EtLac 10% | 0.08 | 0.414 | 1.93 | 1330 | 60 |
| | BS520 | | | | | |
| 13 | NBP-DML 10%- | 0.087 | 0.0487 | 1.79 | 1165 | 60 |
| | BS520 | | | | | |

HTX = Hollytex support membranes.

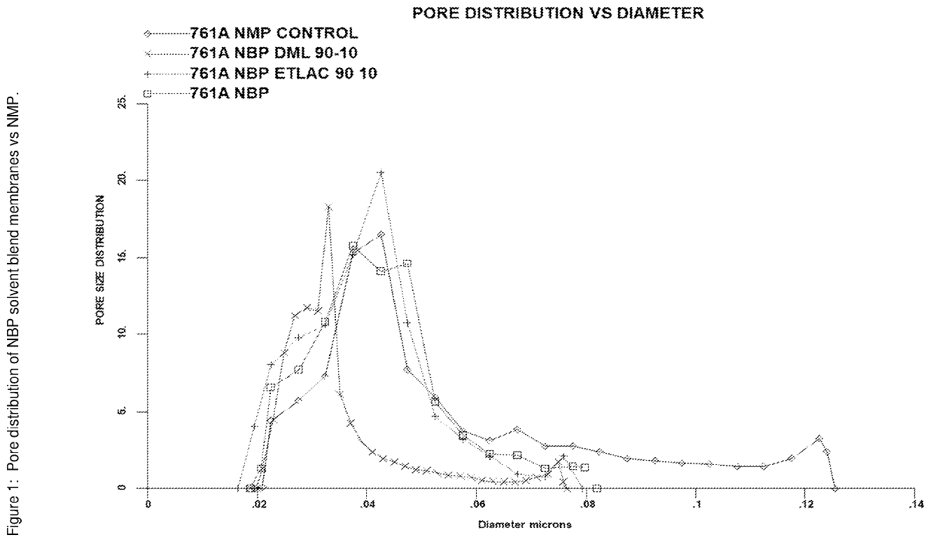

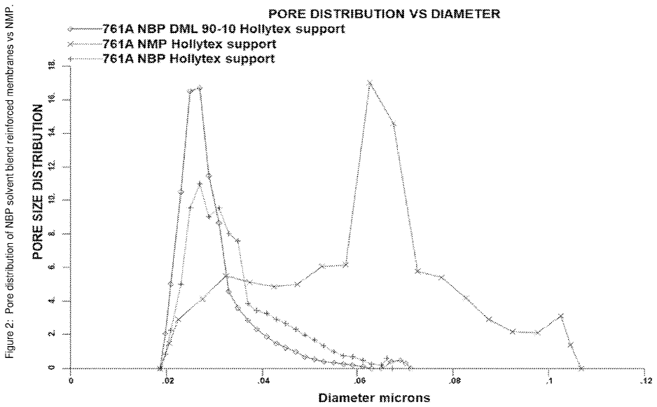

FIGS. 1 and 2 compare pore distributions for NMP control membranes and several of the NBP formulations. The data in table 1 compares the specifications of bubble point diameter (BPD), mean pore diameter (MPD), BPD/MPD ratio, and water permeability. The results show that using the novel dope solution and solvent blends provides from membranes having a unique combination of features which the comparative membranes do not meet

The graphical data in FIGS. 1 and 2 are even more descriptive in showing the difference in pore size distribution. The comparative membranes have a larger pore size range extending above 0.1 μm, and into the microfiltration range. These larger pores will allow larger solute molecules through the membrane, reducing rejection range of these membranes. FIG. 1 shows pore size distribution for unsupported membranes, while FIG. 2 shows supported membrane examples. The supported membranes were made by casting formulations onto Hollytex 3265 non-woven support.

1. A dope solution for making a filtration membrane comprising a PVDF polymer, water soluble polymer and/or hydrogel “polymer H”, a solvent mixture comprising N-butylpyrrolidone and at least one water soluble lactate acid derivative, and optional additives, wherein the solvent mixture comprises at least 50 wt % or greater of N-butylpyrrolidone based on total weight of solvent.

2. (canceled)

3. The dope solution of claim 1, wherein the solvent mixture comprises least 70 wt % or greater of N-butylpyrrolidone based on total weight of solvent.

4. The dope solution of claim 1 wherein the lactic acid derivative comprises at least one of an ester or an amide derivative of lactic acid.

5. The dope solution of claim 1, wherein the lactic acid derivative comprises ester derivatives of lactic acid.

6. The dope solution of claim 4, wherein the lactic acid derivative is selected from the group consisting of methyl lactate, ethyl lactate, propyl lactate, N,N-dimethyl lactamide, and N,N-diethyl lactamide.

7. The dope solution of claim 5, wherein the lactic acid derivatives are selected from the group consisting of methyl lactate, ethyl lactate, propyl lactate and combinations thereof.

8. The dope solution of claim 4, wherein the derivatives comprises N,N-dimethyllactamide, or N,N-diethyllactamide.

9. The dope solution of claim 1, where the PVDF comprises a homopolymer.

10. The dope solution of claim 1, wherein the PVDF is a copolymer comprising at least one monomer unit selected from the group consisting of HFP, TFE, CTFE, VF3, VF, and vinylacetate.

11. The dope solution of claim 1, wherein the PVDF is a copolymer comprising HFP monomer units.

12. The dope solution of claim 1, where the PVDF comprises a blend of different PVDF polymers.

13. The dope solution of claim 1, wherein polymer H is selected from the group consisting of polyvinylpyrrolidone, poly-2-ethyloxazoline, polyethylene glycol and combinations thereof.

14. The dope solution of claim 1, wherein polymer H comprises polyvinylpyrrolidone.

15. The dope solution of claim 1, wherein the optional additives comprise an acrylic resin in an amount of from 1-20% by weight, based on the total weight of polymer P.

16. The dope solution of claim 1, wherein the optional additives comprise at least one of poly-methylmethacrylate, polymethylmethacrylate copolymers, polyhydroxylacrylates, polyhydroxyalkanoates such as polylactic acid, or insoluble hydrogel polymers such as polyhydroxyethylmethacrylate or polyvinylalcohol or combinations thereof.

17. A process for making a PVDF membrane comprising the steps of:
a. providing the dope solution of claim 1,
b. Casting the dope solution at 40 °C or greater temperature into either a flat sheet, hollow fiber, or tubular form followed by immersing the casted dope solution into one or more non-solvent baths to form the porous membrane,
c. Rinsing the porous membrane to remove residual solvent and additives,
d. Optionally treating the membrane with chlorine bleach to further remove additives,
e. Optionally post treating the membrane with wetting agents such as glycerol, propylene glycol, or polyethylene glycol, and
f. Optionally drying the membranes.

18. The polymeric membrane made by the method of claim 17, comprising a maximum pore size (bubble point pore diameter) as measured by bubble point test of less than 90 nm; a mean pore size as measured by capillary flow porometry of 45 nm or less, and wherein the ratio of pore size between bubble point diameter and mean pore diameter is less than 2.5, and wherein the pure water permeability as measured by pressure filtration is 650 LMHB or greater.

19. (canceled)

20. (canceled)

21. A method for filtering a fluid comprising a) providing the polymeric membrane of claim 18, and b) passing a gas or liquid through the membrane.

22. The method of claim 21, wherein the fluid is water.
